(19) United States
(12) Patent Application Publication
(10) Pub. No.: US 2026/0208422 A1
(43) Pub. Date: Jul. 23, 2026

(54) EXTRUSION PLANT FOR BLOW EXTRUSION OF PLASTIC FILMS WITH A SYSTEM FOR REMOVING VAPOURS GENERATED BY THE EXTRUSION PROCESS

(71) Applicant: SYNCRO S.R.L., Busto Arsizio VA (IT)

(72) Inventors: Marco BRANCA, Busto Arsizio VA (IT); Matteo SAPONARA, Busto Arsizio VA (IT); Gabriele CACCIA, Busto Arsizio VA (IT)

(73) Assignee: SYNCRO S.R.L., Busto Arsizio VA (IT)

(21) Appl. No.: 19/140,196

(22) PCT Filed: Feb. 7, 2024
(86) PCT No.: PCT/IB2024/051127

§ 371 Date: Jun. 17, 2025

(30) Foreign Application Priority Data
Feb. 20, 2023 (IT) 102023000002793

(51) Int. Cl. B29C 48/14; B29C 48/10; B29C 48/88; B29C 48/885; B29C 48/92

(52) U.S. Cl. CPC B29C 48/1472; B29C 48/10; B29C 48/885; B29C 48/912; B29C 48/92; B29C 2948/92104; B29C 2948/92466

(57) ABSTRACT

An extrusion plant for the production of plastic films by blow extrusion process is disclosed, including an extrusion head having a die from which in use plastic material is extruded to form a bubble, and a system for removing vapours of monomeric and aliphatic nature resulting from the extrusion process of the plastic material through the extrusion head. The vapour removal system includes a plurality of filtering devices and a suction unit connected to the filtering devices. Each filtering device has a support casing, a filter carried by the support casing to retain the vapours contained in the air sucked in by the suction unit, and an intake duct. The filtering devices are arranged around the extrusion head and beneath the cooling ring and are attached to the cooling ring and are removable from the latter independently of each other.

### TECHNICAL FIELD OF THE INVENTION

The present invention relates to an extrusion plant for blow extrusion of plastic films, provided with a system for removing vapours of monomeric and aliphatic nature resulting from the extrusion of the plastic material at high temperatures, in order to prevent these vapours from condensing on the surfaces, creating a patina that may not only dirty certain devices of the extrusion plant, but also cause malfunctions of these devices, as well as to prevent these vapours from being breathed in by the personnel responsible for the operation of the plant.

### STATE OF THE ART

Today, most production environments in which plants for the blow extrusion of plastic films are installed suffer from the problem of the accumulation of these vapours and their condensation on the various surfaces. However, this problem is generally ignored: the only measure implemented is to ensure general ventilation of the production environment, but this is largely insufficient. The consequence of this is that condensation of these vapours may cause problems in the plant, such as clogging of the filters or clogging of the fans for the air intakes and fir the cooling systems of the switch cabinets. In addition, there is the risk that drops and particles formed by the condensation of such vapours will fall in the vicinity of the bubble and of the air flows necessary for its formation, generating surface defects on the bubble or even puncturing the bubble.

Solutions are known which can also, but not only, be used to remove these vapours, but they all suffer from a number of drawbacks that make them neither useful nor effective.

For example, the CENTRO® system developed by the company Kdesign GmbH is based on the use of suction devices that are positioned on the bubble cage of the extrusion plant and have the function of sucking up the vapours generated by the extrusion process and conveying them to a condensation unit located elsewhere in the plant. Such a known system has first of all the drawback that part of the vapours sucked in may condense directly on the inner surface of the same pipes through which the vapours are conveyed from the suction devices to the condensation unit. Furthermore, such a known system only allows to suck in vapours that remain near the bubble at the same level as that of the bubble cage; however, most of the vapours are generated directly in the area close to the die when the plastic material is still close to the melt temperature and is hit by strong air flows, undergoing the deformation that creates the bubble, and after that these same vapours are dispersed into the air and only a very small part of them reaches the bubble cage.

EP1491319 and U.S. Pat. No. 7,883,327 disclose systems comprising suction devices placed around the bubble cage to remove hot air around the bubble and thus promote its cooling by convection with the environment. Apart from having a different function, these known systems do not overcome the aforementioned drawback that most of the vapours are generated close to the die and disperse into the surrounding environment before reaching the bubble cage.

EP1982819 teaches the use of suction devices, possibly equipped with filters, positioned beneath the cooling ring. Such devices have a different function from that of the system of the present invention, namely to remove the gas (usually air) which is blown downwards from an elevated cooling ring, touching the bubble, in order to cool the bubble itself. The different function these devices have to perform means that they are not optimised for filtering vapours resulting from the extrusion process. Furthermore, such devices are designed to operate only in the presence of a suitable elevated cooling ring having at least one blower channel facing downwards.

US 2010/086632 discloses a vapour removal system comprising a filtering device, arranged near the die of the extrusion head and beneath the cooling ring, and a suction unit connected to the filtering device. The filtering device comprises an annular main body and an annular filter received into an inner chamber of the main body. A similar solution is known from US 2002/018822. A disadvantage of this known solution is that it requires the cooling ring to be moved in order to allow dismantling of the filter contained in the filtering device, which makes maintenance of the vapour removal system more difficult and costly, and also requires to interrupt the production process.

### SUMMARY OF THE INVENTION

It is an object of the present invention to overcome the drawbacks of the prior art discussed above by providing a system for removing vapours generated by plants for the blow extrusion of plastic films that allows in particular to remove a larger amount of vapours than the prior art and that is simpler and less expensive to maintain.

This and other objects are achieved according to the invention by means of a plant for the blow extrusion of plastic films provided with a system for removing vapours generated by the extrusion process as defined in the appended independent claim 1.

Further advantageous aspects of the extrusion plant according to the invention are defined in the dependent claims, the subject-matter of which is to be understood as forming part of the following description.

In summary, the present invention is based on the idea of providing the extrusion plant with a system for removing vapours of a monomeric and aliphatic nature comprising a plurality of filtering devices arranged around the extrusion head and beneath the cooling ring, and a suction unit connected to the filtering devices, wherein each filtering device comprises a main body, a filter carried by the main body for retaining the vapours of monomeric and aliphatic nature contained in the air sucked in by the suction unit through the filtering device, and an intake duct connected on one side to the main body, downstream of the filter, and on the other side to the suction unit, and wherein the filtering devices are attached to the cooling ring so as to be removable from the latter independently of each other.

By virtue of such an arrangement of the filtering devices the amount of vapour sucked in through these devices is maximized and therefore the effectiveness of the removal system is increased.

Furthermore, by virtue of the fact that the intake ducts of the filtering devices are arranged downstream of the filters, and are therefore less prone to condensate deposition from the sucked vapours, the need for cleaning, replacement and/or maintenance of the intake ducts is eliminated, or at least reduced, and the need for a dedicated filtering unit for the intake ducts, which would increase the cost of the system and take up additional space, is avoided.

In addition, such a configuration of the vapour removal system allows each filtering device to be disassembled, for example for the replacement of the respective filter, without requiring the cooling ring to be moved and, above all, without requiring the extrusion process to be interrupted.

### BRIEF DESCRIPTION OF THE DRAWINGS

Further features and advantages of the present invention will become more evident from the following description, given purely by way of non-limiting with reference to the accompanying drawings, in which:

FIG. 1 is a perspective view of a system for the removal of vapours resulting from the extrusion of plastic material according to the present invention, in the mounted condition around the head of an extrusion plant for the production of plastic films by blow extrusion process;

FIG. 2 is a perspective view of the system of FIG. 1, in which the various filtering devices of the system are shown disconnected from each other;

FIG. 3 is a perspective view of one of the filtering devices of the system of FIG. 1; and

FIG. 4 is a schematic cross-sectional view showing the positioning of the filtering device of FIG. 3 in relation to the extrusion head and the cooling ring of the plant of FIG. 1.

### DETAILED DESCRIPTION

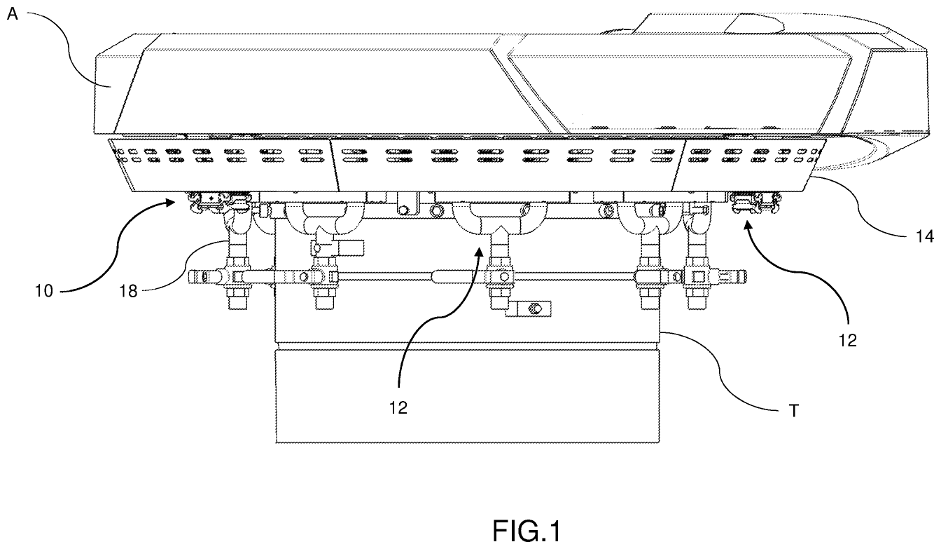

With initial reference to FIG. 1, T and A denote respectively an extrusion head and a cooling ring of an extrusion plant for the production of plastic films by blow extrusion process (hereinafter simply referred to as extrusion plant). The extrusion head T and the cooling ring A are both of per-se-known type and will therefore not be described in detail herein.

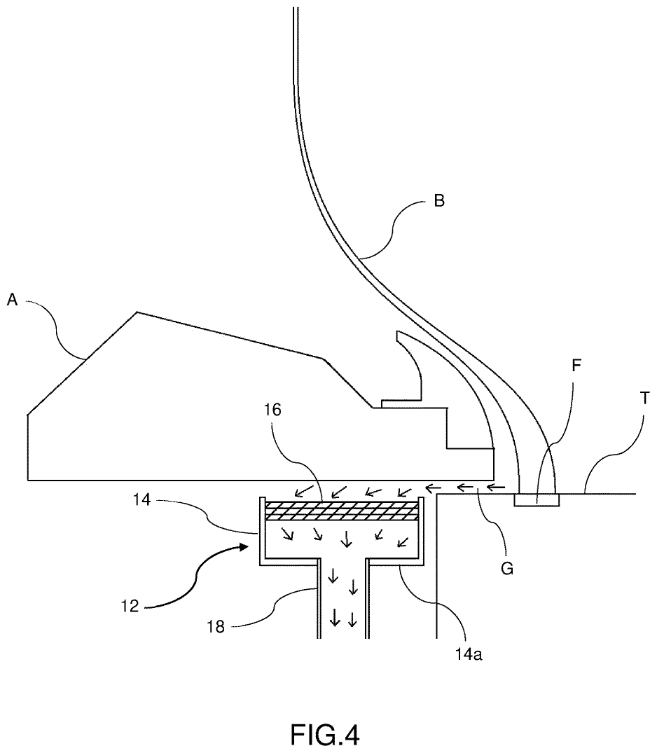

A vapour removal system, generally indicated with 10, is associated with the extrusion plant for removing vapours of monomeric and aliphatic nature resulting from the extrusion process of the plastic material and escaping from a die F of the extrusion head T from which, during operation of the plant, the plastic material flows out to form a bubble B (as shown in FIG. 4). The vapour removal system 10 comprises a plurality of filtering devices 12, separate from each other, which are arranged near the die F, namely around the extrusion head T and beneath the cooling ring A (i.e., upstream of the cooling ring A, with respect to the direction of extrusion of the plastic material, which is facing upwards). In the illustrated embodiment eight filtering devices 12 are provided for, but the number of filtering devices might also be different, for example depending on the size of the extrusion head T. The vapour removal system 10 further comprises a suction unit (not shown, but anyway of a per-se-known type) for drawing air through the filtering devices 12.

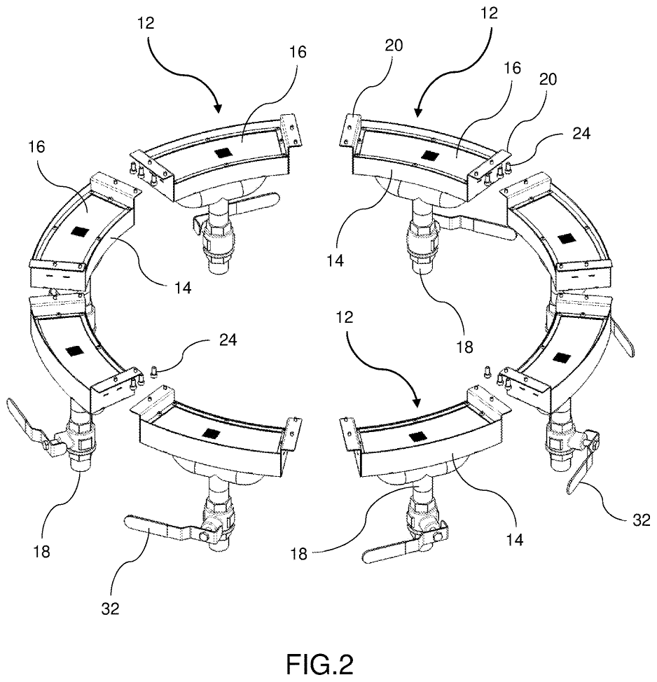

Referring in particular to FIGS. 2 to 4, each filtering device 12 basically comprises a support casing 14, a filter 16 supported by the support casing 14 and an intake duct 18 which on one side is connected to the support casing 14, downstream of the filter 16, and on the other side is connected by a suitable pipe (not shown) to the suction unit.

As can be observed in FIG. 2, in the embodiment proposed herein the support casing 14 of each filtering device 12 has, in plan view, the shape of a circular crown sector. Furthermore, the support casing 14 of each filtering device 12 is open at the top, so as to allow the air to be filtered to enter through a face opposite and parallel to a bottom wall 14a (FIG. 4) of the support casing 14. The support casing may, however, have a general shape different from the one illustrated herein.

The filtering devices 12 are connected to the cooling ring A either directly or, according to an alternative solution (not shown), indirectly via a support structure placed immediately beneath the cooling ring A. For this purpose, according to the illustrated embodiment, the support casings 14 of the filtering devices 12 are each preferably provided with a respective pair of side flanges 20, each having respective holes 22 for the insertion of screws 24 or similar releasable connection means. In this way, the filtering devices 12 can be easily removed from the cooling ring A independently of each other, in particular for their replacement or maintenance.

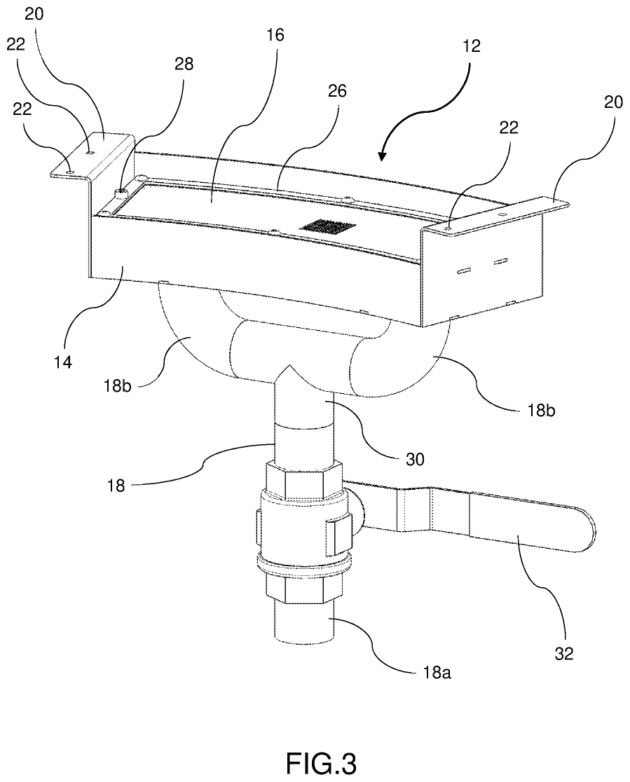

The filters 16 may be of any type suitable for retaining vapours of monomeric and aliphatic nature generated by the extrusion of the plastic material through the extrusion head T and sucked in by the filtering devices 12. For example, the filters 16 may be cloth filters, in which case they will be replaced with new filters once they have been filled with the filtered material, or condensation grid filters, in which case they may be washed and reused. As shown in FIG. 3, the filters 16 are advantageously carried by a support frame 26, which is releasably connected, for example by means of screws 28, to the support casing 14, so that the filters can be easily and quickly removed for being replaced or washed.

Referring in particular to FIG. 3, the intake duct 18 may comprise a first duct section 18a and a pair of second duct sections 18b which are connected on one side to the bottom wall 14a of the support casing 14 and on the other side, via a T-connection member 30, to the first duct section 18a. A more uniform flow of intake air through the filter 16 of each filtering device 12 is thus obtained.

A flow control valve (not shown) is preferably associated with the intake duct 18 of each filtering device 12, which valve is controllable in an automatic manner or in a manual manner, for example by means of an actuating lever 32, to adjust the flow of air flowing through the intake duct 18. More specifically, the flow control valve is positioned along the first duct section 18a of the intake duct 18. In this way, it is possible, for example, to equalise along the circumference of the extrusion head T the flow rate of the air sucked in through the filtering devices 12, which is particularly useful if the pipes connecting the intake ducts 18 of the various filtering devices 12 to the suction unit have different lengths, and it is also possible to close one of the intake ducts 18 to allow the filter 16 of the corresponding filtering device 12 to be replaced and/or cleaned.

Each filtering device 12 may also be provided with sensors of different nature, for example sensors capable of detecting one or more parameters representative of the clogging status of the filter 16, so as to allow to figure out when cleaning or replacement of the filter is necessary, and/or sensors capable of detecting one or more parameters representative of the flow of air sucked in through the filter 16.

Finally, with reference to FIG. 4, it is evident that, due to the fact that the filtering devices 12 are placed around the extrusion head T and beneath the cooling ring A, they are arranged in the vicinity of the die F of the extrusion head T, thus in the optimal position to remove the vapours generated in that area. The amount of vapours sucked in through the filtering devices 12 is thus maximised.

It is also apparent from FIG. 4 that, as the support casing 14 of each filtering device 12 is preferably open at the top, the air flow through the filter 16 of each filtering device 12 is directed substantially vertically, hence substantially perpendicular to the plane in which the filter 16 lies. This makes it possible to increase the area of the air flow through the filter 16 without increasing the vertical size of the filtering devices 12, and therefore without having to move the cooling ring A too far away from the die F. Furthermore, thanks to the particular arrangement of the filtering devices 12, they are able to exploit the air current that naturally forms in that area, especially due to the effect of the pressure difference, produced by the temperature of the melt, which forces the air to flow towards the outside passing through the gap G between the cooling ring A and the extrusion head T, and therefore do not require a too strong sucking action by the suction unit. This has a number of advantages. Firstly, it is possible to use a less powerful suction unit and thus reduce the energy consumption of the suction unit. Secondly, the flow of air sucked in by the filtering devices 12 has a reduced speed, which allows the vapours carried by the air to flow more slowly through the filter 16, thus increasing the amount of monomeric and aliphatic products retained by the filter. Finally, a less strong air sucking action through the filtering devices 12 reduces the risk of disturbing the delicate pressure regime that gives shape and stability to the bubble B produced by the extrusion head T.

A further advantage of the vapour removal system according to the present invention is that the intake ducts 18 of the various filtering devices 12 are arranged downstream of the filters 16 and are therefore less prone to condensate deposition from the sucked vapours. Therefore, the need to provide for cleaning, replacement and/or maintenance of the intake ducts is eliminated, or at least reduced, and, in addition, the need to provide a filtering unit dedicated to the intake ducts, which would increase the cost of the system and take up additional space, is avoided.

The vapour removal system according to the present invention can be easily installed on existing systems, as it does not require disassembly of the cooling ring. In addition, the vapour removal system according to the present invention allows not only to easily disassemble the filter of each filtering device, but also to easily disassemble the filtering device itself, for example for inspection and maintenance purposes, without requiring the cooling ring to be moved and without requiring interruption of the extrusion process.

The present invention has been described so far with reference to preferred embodiments thereof, but it is clear that other embodiments may be envisaged that share the same inventive core with those described herein, as defined by the appended claims.

1. An extrusion plant for the production of plastic films by blow extrusion process, the plant comprising:
an extrusion head with a die, from which die, in use, plastic material is extruded to form a bubble,
a cooling ring located downstream of the extrusion head, and
a vapour removal system for the removal of vapours of monomeric and aliphatic nature resulting from extrusion of the plastic material through the extrusion head,
wherein said vapour removal system comprises a plurality of filtering devices separate from each other, and a suction unit connected to the filtering devices,
wherein each filtering device comprises a support casing, a filter carried by the support casing to retain the vapours of monomeric and aliphatic nature contained in the air sucked in by the suction unit through the filtering device, and an intake duct connected on one side to the support housing, downstream of the filter, and on the other side to the suction unit, and
wherein the filtering devices are arranged beneath the cooling ring and around the extrusion head and are attached to the cooling ring so as to be removable from the cooling ring independently of each other.

2. The extrusion plant of claim 1, wherein the support casing of each filtering device has, in plan view, a circular crown sector shape.

3. The extrusion plant of claim 1, wherein the support casing of each filtering device is open at its top, to allow entry of air to be filtered through a face opposite and parallel to a bottom wall of the support casing.

4. The extrusion plant according of claim 1, wherein the support casing of each filtering device is provided with a pair of side flanges having respective holes into which releasable connection members are inserted for connecting the support casing to the cooling ring.

5. The extrusion plant of claim 1, wherein each filtering device further comprises a support frame which carries the filter and is releasably connected to the support casing.

6. The extrusion plant of claim 1, wherein the vapour removal system further comprises one or more flow control members for adjusting the flow of air through the intake duct of each filtering device.

7. The extrusion plant of claim 1, wherein each filtering device is provided with one or more first sensors for detecting one or more parameters representative of a clogged state of the filter and/or one or more second sensors for detecting one or more parameters representative of a flow of air sucked in through the filter.
